(19) United States
(12) Patent Application Publication
(10) Pub. No.: US 2022/0417337 A1
(43) Pub. Date: Dec. 29, 2022

(54) METHOD AND DEVICE FOR MANAGING SCENE EQUIPMENT, SERVER, AND COMPUTER STORAGE MEDIUM

(71) Applicant: SENSETIME INTERNATIONAL PTE. LTD., Singapore (SG)

(72) Inventors: Jiacheng WU, Singapore (SG); Shuai ZHANG, Singapore (SG); Jinliang LIN, Singapore (SG); Gan XIAO, Singapore (SG)

(21) Appl. No.: 17/364,406

(22) Filed: Jun. 30, 2021

Related U.S. Application Data
(63) Continuation of application No. PCT/IB2021/055735, filed on Jun. 28, 2021.

(30) Foreign Application Priority Data
Jun. 25, 2021 (SG) 10202107014Y

(51) Int. Cl. H04L 29/08; H04L 29/06; G06K 9/00

(52) U.S. Cl. CPC H04L 67/34; H04L 67/42; H04L 67/327; G06K 9/00624

(57) ABSTRACT

A server may exchange data with a plurality of scene equipment. The server acquires a registration request sent by a scene equipment. The server groups the scene equipment according to group identification information in the registration request, acquiring a plurality of groups. The server manages scene equipment of a group in the plurality of groups uniformly according to to-be-processed data reported by the scene equipment of the group. The to-be-processed data include at least one of operating state data or scene data.

### CROSS-REFERENCE TO RELATED APPLICATIONS

This application is a continuation of International Application No. PCT/IB2021/055735, filed on Jun. 28, 2021, which claims the benefit of priority to Singapore Application No. 10202107014Y, filed on Jun. 25, 2021 and titled “METHOD AND DEVICE FOR MANAGING SCENE EQUIPMENT, SERVER, AND COMPUTER STORAGE MEDIUM”. The contents of International Application No. PCT/IB2021/055735 and Singapore Application No. 10202107014Y are incorporated herein by reference in their entireties.

### TECHNICAL FIELD

The disclosure relates to computer network technology, and relates, but is not limited, to a method and device for managing scene equipment, a server, and a computer storage medium.

### BACKGROUND

In the field of Internet of Things (IOT), a complete system is often composed of great-scale collaborating terminal equipment. Each of the terminal equipment serves as a node. The node maintains a smooth network connection with a cloud server. The cloud server controls an operating state of the terminal equipment to ensure a stable convenient smart service to an end user.

Currently, in a system for managing terminal equipment, a great number of terminal equipment and nodes often access a cloud server, and the operating states of all terminal equipment are generally not the same. In some solutions, the system manages all accessing terminal equipment uniformly. That is, the terminal equipment cannot be managed in a targeted manner. In other solutions, when there is a great number of terminal equipment, operation and maintenance personnel may have to control the terminal equipment one by one, increasing difficulty in operation and maintenance.

### SUMMARY

Embodiments of the present disclosure are to provide a method and device for managing scene equipment, a server, and a computer storage medium. By grouping a great number of scene equipment accessing a server and uniformly managing scene equipment of each group, scene equipment may be managed and controlled group by group in a targeted manner, ensuring effective management while lowering difficulty in operation and maintenance.

Embodiments of the present disclosure provide a method for managing scene equipment, applied to a server. The server exchanges data with a plurality of scene equipment.

The method includes: acquiring a registration request sent by a scene equipment, and grouping the scene equipment according to group identification information in the registration request, acquiring a plurality of groups; and uniformly managing scene equipment of a group in the plurality of groups according to to-be-processed data reported by the scene equipment of the group.

The to-be-processed data include at least one of operating state data or scene data.

In some embodiments, uniformly managing the scene equipment of the group includes:

performing at least one of uniform processing or uniform storage on the to-be-processed data reported by the scene equipment of the group.

Here, as there may be different game rules, scenes of application, operating states, etc., for different scene equipment, targeted classification and management of different scene equipment may have to be performed. A server groups a plurality of scene equipment, and uniformly processes and stores to-be-processed data reported by scene equipment in different groups, better meeting a management need.

In some embodiments, the method of claim further includes: establishing a group index for the group; and in response to a failure of a first scene equipment as determined based on the to-be-processed data, searching for a group including the first scene equipment based on the group index.

The first scene equipment may be one of the plurality of scene equipment.

It may be seen that in embodiments of the present disclosure, by establishing index for each group, it may be ensured that in case of a failure of any scene equipment, a group in which the scene equipment is located is quickly determined. Compared to prior art in which search is performed one by one according to the index of each piece of scene equipment, with embodiments of the present disclosure, search is performed according to a group index, speeding up search, improving efficiency in failure positioning.

In some embodiments, the method further includes:

sending a uniform execution command to scene equipment of any one group.

It may be seen that in embodiments of the present disclosure, management is performed by sending a uniform execution command to scene equipment of any one group. That is, scene equipment are not managed one by one, but are managed by group, improving management efficiency.

In some embodiments, the method further includes:

sending a uniform execution command to scene equipment of at least two groups.

It may be seen that in embodiments of the present disclosure, the method supports sending and execution of a single execution command to more than one group, meeting a change in configuration of a public service on scene equipment of different groups, improving management efficiency.

In some embodiments, the uniform execution command includes any one of a shutdown command, a restart command, or a configuration update command.

It may be seen that in embodiments of the present disclosure, the server sends any aforementioned execution command to scene equipment, meeting an operation and maintenance demand in various service scenes.

In some embodiments, the group identification information includes any one of a Universally Unique Identifier UUID, attribute data of the scene equipment, or a scene of application of the scene equipment.

It may be seen that with embodiments of the present disclosure, each piece of scene equipment may be grouped accurately according to any aforementioned group identification information, implementing targeted management of scene equipment of each group, meeting a management requirement.

Embodiments of the present disclosure further provide a device for managing scene equipment, applied to a server. The server exchanges data with a plurality of scene equipment. The device includes a grouping module and a managing module.

The grouping module is configured to acquire a registration request sent by a scene equipment, and grouping the scene equipment according to group identification information in the registration request, acquiring a plurality of groups.

The managing module is configured to uniformly manage scene equipment of a group in the plurality of groups according to to-be-processed data reported by the scene equipment of the group. The to-be-processed data include at least one of operating state data or scene data.

Embodiments of the present disclosure also provide a server, including a processor and a memory for storing a computer program executable on the processor. The processor is configured to execute the computer program to implement any aforementioned method for managing scene equipment.

Embodiments of the present disclosure further provide a system for managing scene equipment, including the server and the plurality of scene equipment. The server exchanges data with the plurality of scene equipment.

Embodiments of the present disclosure further provide a computer storage medium having stored thereon a computer program which, when executed by a processor, implements any aforementioned method for managing scene equipment.

Embodiments of the present disclosure provide a method and device for managing scene equipment, a server, and a computer storage medium. The method may be applied to a server. The server may exchange data with a plurality of scene equipment. The method is as follows. A registration request sent by a scene equipment is acquired. The scene equipment is grouped according to group identification information in the registration request, acquiring a plurality of groups. Scene equipment of a group in the plurality of groups are managed uniformly according to to-be-processed data reported by the scene equipment of the group. The to-be-processed data include at least one of operating state data or scene data.

It may be seen that in embodiments of the present disclosure, a great number of scene equipment accessing the server are grouped according to group identification information, and scene equipment of a group are managed uniformly. As there may be different game rules, scenes of application, operating states, etc., for different scene equipment, targeted classification and management of different scene equipment may have to be performed. A server groups these scene equipment, and uniformly manages operating state data and scene data reported by scene equipment in different groups, ensuring effectiveness in managing terminal equipment. In addition, compared to prior art in which operation and maintenance personnel have to control each terminal equipment one by one, with embodiments of the present disclosure, terminal equipment of a group may be controlled in batch group by group, lowering difficulty in operation and maintenance.

It should be understood that the general description above and the detailed description below are illustrative and explanatory only, and do not limit the present disclosure.

### BRIEF DESCRIPTION OF THE DRAWINGS

The accompanying drawings, which are incorporated in and form a part of this specification, illustrate embodiments consistent with the present disclosure and, together with the description, serve to explain the principles of the present disclosure.

FIG. 1A is a flowchart of a method for managing scene equipment according to embodiments of the present disclosure.

FIG. 1B is a flowchart of grouping scene equipment according to embodiments of the present disclosure.

FIG. 1C is a flowchart of reporting data to a server by scene equipment according to embodiments of the present disclosure.

FIG. 1D is a diagram of a structure of sending an execution command to different groups according to an embodiment of the present disclosure.

FIG. 1E is a diagram of a network architecture for managing scene equipment according to embodiments of the present disclosure.

FIG. 2 is a diagram of a structure of a device for managing scene equipment according to embodiments of the present disclosure.

FIG. 3 is a diagram of a structure of a server according to embodiments of the present disclosure.

### DETAILED DESCRIPTION

The present disclosure is further elaborated below with reference to the drawings and embodiments. It should be understood that an embodiment provided herein is intended but to explain the present disclosure instead of limiting the present disclosure. In addition, embodiments provided below are part of the embodiments for implementing the present disclosure, rather than providing all the embodiments for implementing the present disclosure. Technical solutions recorded in embodiments of the present disclosure may be implemented by being combined in any manner as long as no conflict results from the combination.

It should be noted that in embodiments of the present disclosure, a term such as “including/comprising”, “containing”, or any other variant thereof is intended to cover a non-exclusive inclusion, such that a method or a device including a series of elements not only includes the elements explicitly listed, but also includes other element(s) not explicitly listed, or element(s) inherent to implementing the method or the device. Given no more limitation, an element defined by a phrase “including a . . . ” does not exclude existence of another relevant element (such as a step in a method or a unit in a device, where for example, the unit may be part of a circuit, part of a processor, part of a program or software, etc.) in the method or the device that includes the element.

For example, the method for managing scene equipment provided by embodiments of the present disclosure includes a series of steps. However, the method for managing scene equipment provided by embodiments of the present disclosure is not limited to the recorded steps. Likewise, the device for managing scene equipment provided by embodiments of the present disclosure includes a series of modules. However, devices provided by embodiments of the present disclosure are not limited to include the explicitly recorded modules, and may also include a module required, acquiring relevant information or perform processing according to information.

A term “and/or” herein merely describes an association between associated objects, indicating three possible relationships. For example, by I and/or J, it may mean that there may be three cases, namely, existence of but I, existence of both I and J, or existence of but J. In addition, a term “at least one” herein means any one of multiple, or any combination of at least two of the multiple. For example, including at least one of I, J, and K may mean including any one or more elements selected from a set composed of I, J, and K.

Embodiments of the present disclosure may be applied to a server, and may be operated with many other general-purpose or special-purpose computing system environments or configurations. Here, a server may be a thin client, a thick client, handheld or laptop equipment, a microprocessor-based system, a set-top box, a programmable consumer electronic product, a network personal computer, a small computer system, etc.

A server may be described in the general context of computer system executable instructions (such as a program module) executed by a computer system. Generally, program modules may include a routine, a program, an object program, a component, a logic, a data structure, etc., which perform a specific task or implement a specific abstract data type. A computer system/server may be implemented in a distributed cloud computing environment. In a distributed cloud computing environment, a task is executed by remote processing equipment linked through a communication network. In a distributed cloud computing environment, a program module may be located on a storage medium of a local or remote computing system including storage equipment.

Embodiments of the present disclosure propose a method for managing scene equipment. The method may be applied to a server. The server may exchange data with a plurality of scene equipment. In some embodiments, the server may be a cloud server.

A scene of application of embodiments of the present disclosure is illustrated below.

With embodiments of the present disclosure, state detection and behavior control may be performed on a piece of accessing scene equipment via a server. Scene equipment may collect scene data and operating state data, and report the collected data to the server for auditing and analysis.

In some embodiments, scene equipment may be applied to a game scene, in which a game may be a card game or another game on a game platform, which is not limited in embodiments of the present disclosure.

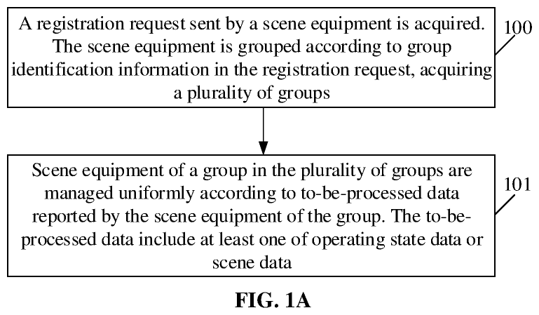

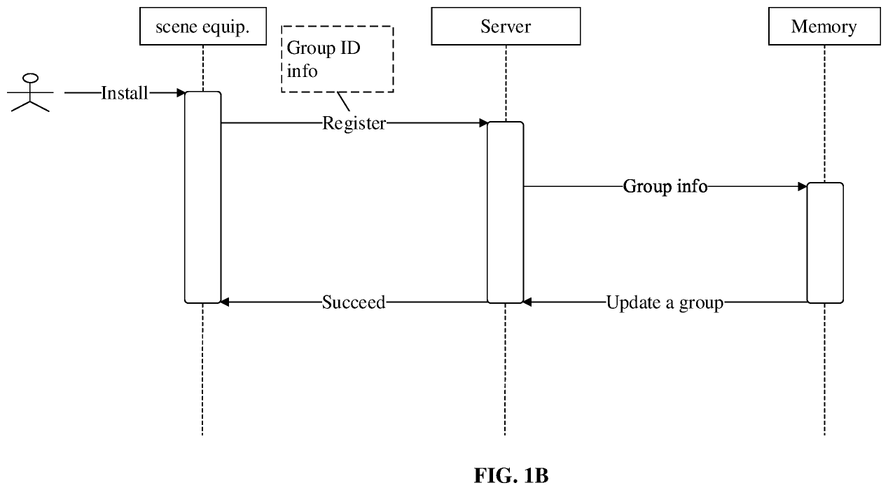

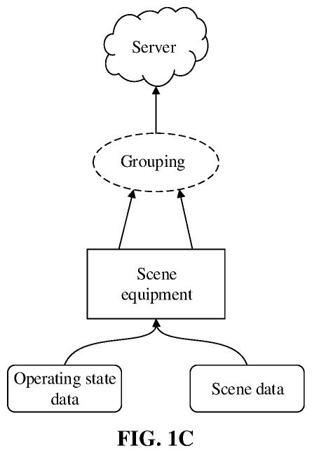

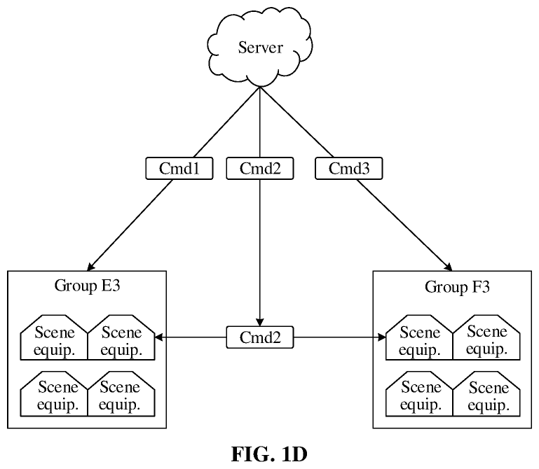

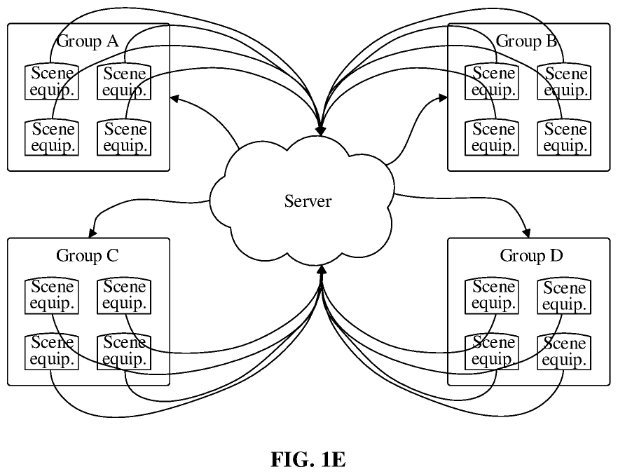

FIG. 1A is a flowchart of a method for managing scene equipment according to embodiments of the present disclosure. As shown in FIG. 1A, the flow may include a step as follows.

In S100, a registration request sent by a scene equipment is acquired. The scene equipment is grouped according to group identification information in the registration request, acquiring a plurality of groups.

In some embodiments, a scene equipment represents one or more pieces of equipment used by a user to play a game. A type of scene equipment may be determined according to a game scene. For example, in case a game in a game scene is a card game, scene equipment may include a game platform, some sensors provided on the game platform, etc. Here, a sensor may be a camera for photographing a game platform.

In some embodiments, when a plurality of scene equipment access a server, each of the plurality of scene equipment sends a registration request to the server. The server may perform authentication on such registration requests received, and groups authenticated scene equipment. The types of the plurality of scene equipment may be the same or different.

In some embodiments, a scene equipment sends a registration request to the server via a data transmission protocol. Here, the data transmission protocol may be a Transmission Control Protocol (TCP), or may be another transmission protocol for data exchange.

In embodiments of the present disclosure, the server may group, according to group identification information in a registration request, each piece of scene equipment that has been authenticated. In some embodiments, the group identification information may include any one of a Universally Unique Identifier UUID, attribute data of the scene equipment, or a scene of application of the scene equipment.

In some embodiments, each piece of scene equipment has a corresponding UUID identifying the scene equipment. In case the group identification information includes a UUID, the UUID of each piece of scene equipment may be divided into a set interval, grouping any scene equipment corresponding to each UUID in one interval into a group, thereby acquiring a plurality of groups. For example, UUIDs corresponding to scene equipment D1 to scene equipment D10 are 1 to 10, respectively. If set intervals are set according to 5, two groups may be acquired. Scene equipment D1 to scene equipment D5 may be one group. Scene equipment D6 to scene equipment D10 may be the other group.

In some embodiments, attribute data of scene equipment may include basic attribute information of the scene equipment, such as information on a size and a shape of a game platform, and a number, locations, and models of sensors disposed on the game platform, etc. In case the group identification information includes the attribute data of the scene equipment, each piece of scene equipment may be grouped according to some or all of the basic attribute information in the attribute data of the scene equipment. For example, each piece of scene equipment may be grouped according to the size of the game platform and the shape of the game platform.

In some embodiments, in case the group identification information includes a scene of application of the scene equipment, each piece of scene equipment may be grouped according to the scene of application of the scene equipment. For example, when a scene of application of the scene equipment corresponds to a plurality of card games with different game rules, scene equipment using the same card game rule may be grouped into one group, thereby acquiring a plurality of groups.

FIG. 1B is a flowchart of grouping scene equipment according to embodiments of the present disclosure. As shown in FIG. 1B, first, a staff member may install a plurality of scene equipment as needed. Then, each of the plurality of scene equipment may send a registration request to a server. Then, the server may acquire group information according to group identification information in the registration request, store the group information in memory, and group each piece of scene equipment according to the group information stored, acquiring each group updated. The group identification information may include any one of a Universally Unique Identifier UUID, attribute data of the scene equipment, or a scene of application of the scene equipment. Finally, the server may return access succeed information to scene equipment in each group. In this case, scene equipment in each group have successfully joined the network. For scene equipment that has successfully joined the network, some customized application software may be executed, providing a smart service for an end user.

In S101, scene equipment of a group in the plurality of groups are managed uniformly according to to-be-processed data reported by the scene equipment of the group. The to-be-processed data include at least one of operating state data or scene data.

In embodiments of the present disclosure, after acquiring the plurality of groups according to the above steps, it may be determined that any scene equipment of each of the plurality of groups has accessed the server successfully and become a node in the network. In this case, at least one of the operating state data and the scene data reported by scene equipment of each group may be received.

In some embodiments, operating state data represent data related to an operating state of a scene equipment, such as orientation information of a camera, on or off information of a scene equipment, etc. Scene data may represent game-related data acquired by a scene equipment. For example, scene data may be present card information on a game platform, or may be money substitute information on a money substitute present on the game platform. Here, the card information may include information on a card type, a card number, etc. The money substitute information may include information on a face value of the money substitute, a type of the money substitute, a number of the money substitute, identity of an owner of the money substitute, etc.

In some embodiments, scene equipment of a group may report its own operating state data to the server in real time during operation, so that the server may monitor an online state of the scene equipment in real time through the operating state data reported by the scene equipment, ensuring normal operation of the scene equipment.

In some embodiments, scene equipment of a group may report collected scene data to the server according to a set time interval during operation, so that the server may perform uniform management on the scene data reported by the group of scene equipment.

Here, the set time interval may be set according to an actual scene, such as to be 3 s, 5 s, etc., which is not limited to embodiments of the present disclosure.

In some embodiments, it is assumed that there are repeated operating state data or scene data among different scene equipment in the same group. The repeated operating state data or scene data may be deleted. That is, when each group is managed, it is not required to keep a great amount of repeated data, effectively reducing data redundancy.

FIG. 1C is a flowchart of reporting data to a server by scene equipment according to embodiments of the present disclosure. As shown in FIG. 1C, scene equipment may acquire, during operation, its own operating state data and scene data. The scene equipment may report its own operating state data to the server in real time, and the server may monitor the online state of the scene equipment in real time through the operating state data reported by the scene equipment. The scene equipment may report the scene data to the server periodically according to a set time interval, and the server may process the scene data according to a group in which the scene equipment is located.

In some embodiments, scene equipment of a group may be managed uniformly as follows. At least one of uniform processing or uniform storage may be performed on the to-be-processed data reported by the scene equipment of the group.

In some embodiments, the server performs uniform processing and uniform storage in units of groups on the to-be-processed data reported by scene equipment of each group when receiving the to-be-processed data reported by the scene equipment of the group. That is, to-be-processed data in the same group are processed and stored in the same manner. Here, to-be-processed data in different groups may be processed and stored in the same manner, or in different manners.

Here, as there may be different game rules, scenes of application, operating states, etc., for different scene equipment, targeted classification and management of different scene equipment may have to be performed. A server groups a plurality of scene equipment, and uniformly processes and stores to-be-processed data reported by scene equipment in different groups, better meeting a management need.

In some embodiments, the method may further include a step as follows. A group index may be established for each group. When it is determined based on the to-be-processed data that there is a failure of a first scene equipment, search may be performed for a group including the first scene equipment based on the group index. The first scene equipment may be one of the plurality of scene equipment.

In embodiments of the present disclosure, before a group of scene equipment is managed uniformly, an index is first established for each group. In this way, it is ensured that when any one scene equipment fails, the group in which the scene equipment is located may be quickly found according to the index, thereby determining the failing scene equipment in the group.

It may be seen that, compared to prior art in which search is performed according to the index of each piece of scene equipment, search is performed by group, effectively improving efficiency in failure positioning.

In some embodiments, the method may further include a step as follows. A uniform execution command may be sent to scene equipment of any one group. Here, the uniform execution command may include any one of a shutdown command, a restart command, or a configuration update command.

In embodiments of the present disclosure, the server sends any of the above execution commands to scene equipment, meeting an operation and maintenance requirement n different scenes.

In embodiments of the present disclosure, a single execution command sent by a server may be executed uniformly by scene equipment in the same group. For example, in case scene equipment are grouped into a group E1 and a group F1, a server may send a uniform shutdown command to scene equipment in the group E1, and send a uniform restart command to scene equipment in the group F1. Scene equipment in the group E1 receiving the shutdown command may execute a shutdown operation. Scene equipment in the group F1 receiving the restart command may execute a restart operation. Here, the shutdown operation and the restart operation may be executed in parallel.

It may be seen that in embodiments of the present disclosure, different execution commands are sent to different groups of scene equipment, meeting a demand for managing scene equipment in different service scenes, supporting parallel execution of multiple service scenes, improving management efficiency.

In some embodiments, the method may further include a step as follows. A uniform execution command may be sent to scene equipment of at least two groups.

In embodiments of the present disclosure, a single execution command sent by a server may be executed uniformly by scene equipment in different groups. For example, in case scene equipment are grouped into a group E2 and a group F2, a server may send a uniform shutdown command to scene equipment in group E2 and group F2. All scene equipment in the group E2 and the group F2 receiving the shutdown command may execute a shutdown operation.

FIG. 1D is a diagram of a structure of sending an execution command to different groups according to an embodiment of the present disclosure. As shown in FIG. 1D, a server sends an execution command cmd1 to a group E3. Scene equipment in the group E3 receive and then execute the execution command cmd1. The server sends an execution command cmd3 to the group F3. Scene equipment in the group F3 receive and execute the execution command cmd3. The server sends an execution command cmd2 to the group E3 and the group F3, so that when receiving the execution command cmd2, scene equipment in the group E3 and the group F3 all execute the command.

It may be seen that in embodiments of the present disclosure, the method supports sending and execution of a single execution command to more than one group, meeting a change in configuration of a public service on scene equipment of different groups, improving management efficiency.

FIG. 1E is a diagram of a network architecture for managing scene equipment according to embodiments of the present disclosure. As shown in FIG. 1E, the network architecture includes a server and a plurality of scene equipment. When the plurality of scene equipment access the server, a registration request is first sent to the server. The server authenticates the registration request and groups a scene equipment according to group identification information in the registration request, so that a group A, a group B, a group C, and a group D may be acquired. In this case, scene equipment in each group access the server successfully and become nodes in one network. Here, by grouping each piece of scene equipment, scene equipment may be allowed to support different operating states and processing logics, supporting parallel operation of multiple service scenes, greatly reducing difficulty in operation and maintenance.

In a practical application, S100 to S101 may be implemented using a processor in a server. The processor may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing Unit (CPU), a controller, a microcontroller, a microprocessor, etc.

Embodiments of the present disclosure provide a method and device for managing scene equipment, a server, and a computer storage medium. The method may be applied to a server. The server may exchange data with a plurality of scene equipment. The method is as follows. A registration request sent by a scene equipment is acquired. The scene equipment is grouped according to group identification information in the registration request, acquiring a plurality of groups. Scene equipment of a group in the plurality of groups are managed uniformly according to to-be-processed data reported by the scene equipment of the group. The to-be-processed data include at least one of operating state data or scene data. It may be seen that in embodiments of the present disclosure, a great number of scene equipment accessing the server are grouped according to group identification information, and scene equipment of a group are managed uniformly. As there may be different game rules, scenes of application, operating states, etc., for different scene equipment, targeted classification and management of different scene equipment may have to be performed. A server groups these scene equipment, and uniformly manages operating state data and scene data reported by scene equipment in different groups, ensuring effectiveness in managing terminal equipment. In addition, compared to prior art in which operation and maintenance personnel have to control each terminal equipment one by one, with embodiments of the present disclosure, terminal equipment of a group may be controlled in batch group by group, lowering difficulty in operation and maintenance.

Embodiments of the present disclosure will be illustrated with reference to a scene of application, in which a game scene is a smart casino scene, a scene equipment is a gaming table, and a server is a cloud server.

In a scene of uniformly sending an execution command, operation and maintenance personnel are to execute an upgrade command M on some gaming tables in a smart casino, and execute an upgrade command N on some other gaming tables. It is known that gaming tables may be divided into a group 1 and a group 2 according to a scene of application of a gaming table. The operation and maintenance personnel may send, through the cloud server, an upgrade command M to the group 1, and an upgrade command N to the group 2, wait for the upgrade commands to be executed successfully, and then conclude.

In a failure positioning scene, if a gaming table in a smart casino crashes, operation and maintenance personnel may detect, at a cloud server, a group in which the gaming table is located, and time and information relating to last report of operating state data, and therefore quickly locate a location of failure in the smart casino and go to overhaul the gaming table. Thereafter, by analyzing collected data and comparing the data to other gaming tables of the same group, an error may be troubleshot and the gaming table may be brought back online.

A smart casino may serve as a smart betting system of in-depth combination of a large casino and an IOT. A gaming table, i.e., a node, provides a smart service to a user. State detection and behavior control are performed on a gaming table through a network cloud server. A gaming table collects tabletop data (scene data) and an operating log (operating state data) and reports the data to the cloud server for auditing and analysis.

It may be seen that by grouping the gaming tables, processing logic of different scenes of application may be effectively distinguished, so that gaming tables may be grouped with a higher degree of freedom at an operation and maintenance level, supporting parallel operation of multi-service scenes of a smart casino, greatly reducing difficulty in operation and maintenance. In addition, a gaming table collects tabletop data and an operating log and reports the collected data to a cloud server. The cloud server may effectively reduce a great amount of data redundancy according to grouping logic processing. In addition, storage and processing by group may provide index optimization, improving efficiency in failure positioning.

A person having ordinary skill in the art may understand that in a method of a specific implementation, the order in which the steps are put is not necessarily a strict order in which the steps are implemented, and does not form any limitation to the implementation process. A specific order in which the steps are implemented should be determined based on a function and a possible intrinsic logic of the steps.

Based on the method for managing scene equipment set forth in foregoing embodiments, embodiments of the present disclosure provide a device for managing scene equipment. The device is applicable to a server. The server exchanges data with a plurality of scene equipment.

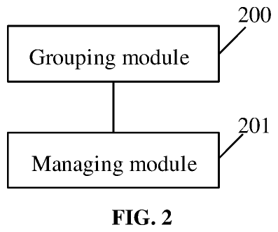

FIG. 2 is a diagram of a structure of a device for managing scene equipment according to embodiments of the present disclosure. As shown in FIG. 2, the device may include a grouping module and a managing module.

The grouping module 200 is configured to acquire a registration request sent by a scene equipment, and grouping the scene equipment according to group identification information in the registration request, acquiring a plurality of groups.

The managing module 201 is configured to uniformly manage scene equipment of a group in the plurality of groups according to to-be-processed data reported by the scene equipment of the group. The to-be-processed data include at least one of operating state data or scene data.

In some embodiments, the managing module 201 is configured to uniformly manage the scene equipment of the group by:

performing at least one of uniform processing or uniform storage on the to-be-processed data reported by the scene equipment of the group.

In some embodiments, the managing module 201 is further configured to: establish a group index for the group; and in response to a failure of a first scene equipment as determined based on the to-be-processed data, search for a group including the first scene equipment based on the group index.

The first scene equipment may be one of the plurality of scene equipment.

In some embodiments, the managing module 201 is further configured to send a uniform execution command to scene equipment of any one group.

In some embodiments, the managing module 201 is further configured to send a uniform execution command to scene equipment of at least two groups.

In some embodiments, the uniform execution command includes any one of a shutdown command, a restart command, or a configuration update command.

In some embodiments, the group identification information includes any one of a Universally Unique Identifier UUID, attribute data of the scene equipment, or a scene of application of the scene equipment.

In practical applications, both the grouping module 200 and the managing module 201 may be implemented using a processor in a server. The processor may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing Unit (CPU), a controller, a microcontroller, a microprocessor, etc.

Embodiments of the present disclosure further provide a system for managing scene equipment. The system includes an aforementioned server and a plurality of scene equipment. The server exchanges data with the plurality of scene equipment.

In addition, various functional modules in the embodiments may be integrated in one processing unit, or exist as separate physical units respectively. Alternatively, two or more such units may be integrated in one unit. The integrated unit may be implemented in form of hardware or software functional unit(s).

When implemented in form of a software functional module and sold or used as an independent product, an integrated unit herein may be stored in a computer-readable storage medium. Based on such an understanding, the essential part of the technical solution of the embodiments or a part contributing to prior art or all or part of the technical solution may appear in form of a software product, which software product is stored in storage media, and includes a number of instructions for allowing computer equipment (such as a personal computer, a server, network equipment, and/or the like) or a processor to execute all or part of the steps of the methods of the embodiments. The storage media include various media that can store program codes, such as a U disk, a mobile hard disk, Read Only Memory (ROM), Random Access Memory (RAM), a magnetic disk, a CD, and/or the like.

Specifically, the computer program instructions corresponding to a method for managing scene equipment in the embodiments may be stored on a storage medium such as a CD, a hard disk, a USB flash disk, etc. When read by a server or executed, computer program instructions in the storage medium corresponding to a method for managing scene equipment implement any method for managing scene equipment of the foregoing embodiments.

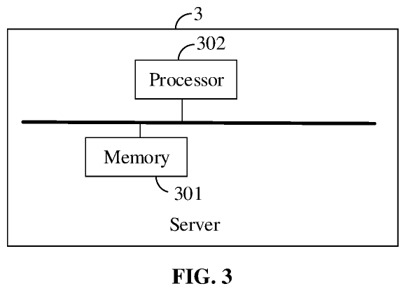

Based on a technical concept same as that of a foregoing embodiment, referring to FIG. 3, which shows a server 3 provided in embodiments of the present disclosure. The server may include a memory 301 and a processor 302.

The memory 301 is configured to store a computer program and data.

The processor 302 is configured to execute the computer program stored in the memory to implement any method for managing scene equipment of the foregoing embodiments.

In a practical application, the memory 301 may be a volatile memory such as RAM; or non-volatile memory such as ROM, flash memory, a Hard Disk Drive (HDD), or a Solid-State Drive (SSD); or a combination of the foregoing types of memories, and provide instructions and data to the processor 302.

The processor 302 may be at least one of an ASIC, a DSP, a DSPD, a PLD, a FPGA, a CPU, a controller, a microcontroller, and a microprocessor. It is understandable that, for different equipment, the electronic device used to implement the above-mentioned processor functions may also be the other, which is not specifically limited in embodiments of the present disclosure.

In some embodiments, a function or a module of a device provided in embodiments of the present disclosure may be configured to implement a method described in a method embodiment herein. Refer to description of a method embodiment herein for specific implementation of the device, which is not repeated here for brevity.

The above description of the various embodiments tends to emphasize differences in the various embodiments. Refer to one another for identical or similar parts among the embodiments, which are not repeated for conciseness.

Methods disclosed in method embodiments of the present disclosure may be combined with each other as needed to acquire a new method embodiment, as long as no conflict results from the combination.

Features disclosed in product embodiments of the present disclosure may be combined with each other as needed to acquire a new product embodiment, as long as no conflict results from the combination.

Features disclosed in method or device embodiments of the present disclosure may be combined with each other as needed to acquire a new method or device embodiment, as long as no conflict results from the combination.

Through the description of the above embodiments, a person having ordinary skill in the art may clearly understand that a method of the above embodiments may be implemented by hardware, or often better, by software plus a necessary general hardware platform. Based on this understanding, the essential part or the part contributing to prior art of a technical solution of the present disclosure may be embodied in form of a software product. The computer software product is stored in a storage medium (such as ROM/RAM, a magnetic disk, and a CD) and includes a number of instructions that allow terminal (which may be a mobile phone, a computer, a server, an air conditioner, or a network device, etc.) to execute a method described in the various embodiments of the present disclosure.

Embodiments of the present disclosure are described above with reference to the drawings. However, the present disclosure is not limited to the above-mentioned specific implementations. The above-mentioned specific implementations are only illustrative but not restrictive. Inspired by the present disclosure, a person having ordinary skill in the art may further implement many forms without departing from the purpose of the present disclosure and the scope of the claims. These forms are all covered by protection of the present disclosure.

1. A method for managing scene equipment, applied to a server, the server exchanging data with a plurality of scene equipment, the method comprising:
acquiring a registration request sent by each scene equipment of the plurality of scene equipment, and grouping the each scene equipment according to group identification information in the registration request to acquire a plurality of groups;
uniformly managing scene equipment of each group in the plurality of groups according to to-be-processed data reported by the scene equipment of the each group, the to-be-processed data comprising at least one of operating state data or scene data; and
in response to there being repeated operating state data or scene data among different scene equipment in a same group, deleting the repeated operating state data or scene data.

2. The method of claim 1, wherein uniformly managing the scene equipment of the each group comprises:
performing at least one of uniform processing or uniform storage on the to-be-processed data reported by the scene equipment of the each group.

3. The method of claim 1, further comprising:
establishing a group index for the each group; and
in response to a failure of a first scene equipment as determined based on the to-be-processed data, searching for a group comprising the first scene equipment based on the group index, the first scene equipment being one of the plurality of scene equipment.

4. The method of claim 1, further comprising:
sending a uniform execution command to scene equipment of any one group.

5. The method of claim 1, further comprising:
sending a uniform execution command to scene equipment of at least two groups.

6. The method of claim 5, wherein the uniform execution command comprises any one of a shutdown command, a restart command, or a configuration update command.

7. The method of claim 1, wherein the group identification information comprises any one of a Universally Unique Identifier (UUID), attribute data of the scene equipment, or a scene of application of the each scene equipment.

8. A server, comprising a processor and a memory for storing a computer program executable on the processor, the server exchanging data with a plurality of scene equipment, the processor being configured to implement:
acquiring a registration request sent by each scene equipment of the plurality of scene equipment, and grouping the each scene equipment according to group identification information in the registration request to acquire a plurality of groups;
uniformly managing scene equipment of each group in the plurality of groups according to to-be-processed data reported by the scene equipment of the each group, the to-be-processed data comprising at least one of operating state data or scene data; and
in response to there being repeated operating state data or scene data among different scene equipment in a same group, deleting the repeated operating state data or scene data.

9. The server of claim 8, wherein the processor is configured to uniformly manage the scene equipment of the each group by:
performing at least one of uniform processing or uniform storage on the to-be-processed data reported by the scene equipment of the each group.

10. The server of claim 8, wherein the processor is further configured to implement:
establishing a group index for the each group; and
in response to a failure of a first scene equipment as determined based on the to-be-processed data, searching for a group comprising the first scene equipment based on the group index, the first scene equipment being one of the plurality of scene equipment.

11. The server of claim 8, wherein the processor is further configured to implement:
sending a uniform execution command to scene equipment of any one group.

12. The server of claim 8, wherein the processor is further configured to implement:
sending a uniform execution command to scene equipment of at least two groups.

13. The server of claim 12, wherein the uniform execution command comprises any one of a shutdown command, a restart command, or a configuration update command.

14. The server of claim 8, wherein the group identification information comprises any one of a Universally Unique Identifier (UUID), attribute data of the scene equipment, or a scene of application of the each scene equipment.

15. A non-transitory computer storage medium having stored thereon a computer program which, when executed by a processor, implements:
acquiring a registration request sent by each scene equipment of a plurality of scene equipment, and grouping the each scene equipment according to group identification information in the registration request to acquire a plurality of groups;
uniformly managing scene equipment of each group in the plurality of groups according to to-be-processed data reported by the scene equipment of the each group, the to-be-processed data comprising at least one of operating state data or scene data; and
in response to there being repeated operating state data or scene data among different scene equipment in a same group, deleting the repeated operating state data or scene data.

16. The non-transitory computer storage medium of claim 15, wherein the computer program is for uniformly managing the scene equipment of the each group by:
performing at least one of uniform processing or uniform storage on the to-be-processed data reported by the scene equipment of the each group.

17. The non-transitory computer storage medium of claim 15, wherein the computer program is further for:
establishing a group index for the each group; and
in response to a failure of a first scene equipment as determined based on the to-be-processed data, searching for a group comprising the first scene equipment based on the group index, the first scene equipment being one of the plurality of scene equipment.

18. The non-transitory computer storage medium of claim 15, wherein the computer program is further for:
sending a uniform execution command to scene equipment of any one group.

19. The non-transitory computer storage medium of claim 15, wherein the computer program is further for:
sending a uniform execution command to scene equipment of at least two groups.
